(19) United States
(12) Patent Application Publication
(10) Pub. No.: US 2012/0248077 A1
(43) Pub. Date: Oct. 4, 2012

(54) Soldering device for forming electrical solder connections in a disk drive unit

(75) Inventors: Yiusing Ho, Hong Kong (CN); Canhua Chen, Hong Kong (CN); Guohong Lu, Hong Kong (CN); Baoquan Wang, Hong Kong (CN)

(73) Assignee: SAE Magnetics (H.K.) Ltd., Hong Kong (CN)

(21) Appl. No.: 13/067,738

(22) Filed: Jun. 22, 2011

(30) Foreign Application Priority Data
Mar. 31, 2011 (CN) 201110079849.9

(51) Int. Cl. B23K 26/00

(52) U.S. Cl. 219/121.65

(57) ABSTRACT

A soldering device for forming electrical solder connections in a disk drive unit comprises a nozzle device comprising at least two separated movable housings that provides a passage, the upper ends of the housings form an entrance, and the lower ends of the housings form a nozzle; and an actuating device connecting with the nozzle device and arranged for controlling the housings of the nozzle device to move together or apart, thereby controlling the inner diameter size of the nozzle. The present invention provides movable housings of the nozzle device so as to make the size of the nozzle controllable, finally benefits to perform a solder connection.

This application claims the benefit of Chinese Patent Application No. 201110079849.9, filed on Mar. 31, 2011, the entire content of which is hereby incorporated by reference in this application.

### FIELD OF THE INVENTION

The present invention relates to a soldering device and, more particularly, to a soldering device for forming electrical solder connections in a disk drive unit.

### BACKGROUND OF THE INVENTION

Hard disk drives are common information storage devices. Referring to FIG. 1a, a conventional disk drive 100 essentially consists of a series of rotatable disks 101 mounted on a spindle, and a Head Stack Assembly (HSA) 130 which is rotatable about an actuator arm axis 102 for accessing data tracks on disks during seeking. The HSA 130 includes at least one arm 104 and HGA 150.

Referring to FIG. 1b, the HGA 150 includes a slider 103 (shown in FIG. 1c) having a reading/writing transducer (not shown) imbedded therein, a suspension 190 to load or suspend the slider 103 thereon. When the disk drive is on, a spindle motor 102 will rotate the disk 101 at a high speed, and the slider 103 will fly above the disk 101 due to the air pressure drawn by the rotated disk 101. The slider 103 moves across the surface of the disk 101 in the radius direction under the control of the VCM. With a different track, the slider 103 can read data from or write data to the disk 101.

FIG. 1c shows a conventional suspension, the suspension 190 includes a load beam 106, a base plate 108, a hinge 107 and a flexure 105, all of which are assembled together.

The load beam 106 is connected to the base plate 108 by the hinge 107. A locating hole 112 is formed on the load beam 106 for aligning the load beam 106 with the flexure 105. And the load beam 106 is welded with the flexure for increasing the strength of the entire structure.

The base plate 108 is used to enhance structure stiffness of the whole HGA 150. A mounting hole. 113 is formed on one end of the base plate 108 for mounting the whole HGA 150 to the motor arm 104 (referring to FIG. 1a). Another hole 110 is formed on the other end of the base plate 108, through which the base plate 108 connects with the flexure 105.

The flexure 105 is made of flexible material and runs from the hinge 107 to the load beam 106. The flexure 105 has a proximal end 119 adjacent the hinge 107 and a distal end 118 adjacent the load beam 106. A locating hole (not shown) is formed on the distal end 118 of the flexure 105 and aligned with the locating hole 112 of the load beam 106, thus obtaining a high assembly precision. A suspension tongue 116 is provided at the distal end 118 of the flexure 105 to carry the slider 103 thereon.

FIG. 1c shows a more detailed structure of the flexure 105 shown in FIG. 1b. As illustrated in the figure, a plurality of suspension traces 120 is formed on the flexure 105 along length direction thereof. One end of the traces 120 is electrically connected to a preamplifier (not shown), and the other end thereof extends into the suspension tongue 116. The suspension tongue 116 has a plurality of bonding pads (not shown) formed thereon for coupling the slider 103. Concretely, the slider 103 is mounted on the suspension tongue 116, and the slider 103 has multiple bonding pads (not shown) formed thereon. The bonding pads of the slider 103 and the suspension tongue 116 are electrically connected together by solder balls 135.

The following is a description of a solder ball connection method for connecting the slider 103 to the suspension tongue 116.

FIG. 2 is a cross section view of the major portion of the HGA 150, and a partial cross sectional view of the soldering device 180. The load beam 106 is not illustrated here so as to simplify the description.

When carrying out a solder ball connection, the inclined HGA 150 is held by a holder (not shown) so that the connection surface 117a and the connection surface 116a of the suspension tongue 116 face each other substantially perpendicular and each of those connection surfaces 117a and 116a is inclined substantially at 45° relative to a line 115.

The conventional soldering device 180 commonly includes a nozzle device 181 and a solder ball feeding device (not shown). As shown in FIG. 3, the nozzle device 181 is tube shape which has a housing 182, an inner hollow passage 183 and a tip called nozzle 184. The solder ball feeding device stores many solder balls 135 and delivers one solder ball 135 to the nozzle 184 from the upper opening of the housing 182 through its passage 183 after the nozzle 184 is disposed at a predetermined position. At this time, the soldering device 180 supplies a nitrogen gas (N₂) so as to prompt the solder ball 135 to move to the nozzle 184 with the action of the gravity.

In this state, the soldering device 180 applies a laser beam to the solder ball 135 through the inner hollow passage 183 of the nozzle device 181 so as to make the solder ball 135 reflow. The solder ball 135 is then melted in this reflowing, getting both connection surfaces 117a and 116a of the slider 103 and the suspension tongue 116 wet and connected together. The nitrogen gas supplied at this time presses the melted solder against each connection surfaces 117a, 116a and covers the solder so as to be prevented from oxidation.

In the conventional design of the nozzle device 181, the inner diameter of the nozzle 184 is configured smaller than that of the solder ball 135, so as to maintain the solder ball 135 at the nozzle 184. In addition, as the housing 182 of the nozzle device 181 is a unitary structure, thus the size of the inner diameter of the nozzle 184 is fixed. For reflowing the melted solder ball 135 to the connection surfaces 117a and 116a, the laser beam must be emitted before the solder ball 135 reflows. That is, the solder ball 135 is melted at the nozzle 184, which causes the melted material of the solder ball 135 contacts with the nozzle 184, in turn, brings residue of the solder ball at the inner wall of the nozzle 184 which affects the using quality of the nozzle device 180. For reducing the residue at the nozzle 184, a persistent laser beam should emit until all the material reaches the connection surfaces 117a and 116a. However, the energy of the laser beam is increased, which causes the high energy consumption.

Thus, there is a need for an improved soldering device to overcome the drawbacks mentioned above.

### SUMMARY OF THE INVENTION

One aspect of the present invention is to provide a soldering device for forming electrical solder connections in a disk drive unit, which provides movable housings of the nozzle device, and in turn, makes the size of the nozzle controllable, finally benefits to perform a solder connection.

To achieve above objective, a soldering device for forming electrical solder connections in a disk drive unit, comprises a nozzle device comprising at least two separated movable housings that provides a passage, the upper ends of the housings form an entrance, and the lower ends of the housings form a nozzle; an actuating device connecting with the nozzle device and arranged for controlling the housings of the nozzle device to move together or apart, thereby controlling the inner diameter size of the nozzle; a solder ball feeding device operable to deliver a single solder ball to the passage via the entrance or the nozzle; a pressurized gas feeding device operable to supply pressurized gas to the passage, thereby controlling the dropping speed of the solder ball in the passage; and a laser generator operable to emit a laser beam through the passage, thereby melting and reflowing the solder ball.

As a preferred embodiment, the actuating device comprises a vertical actuator which includes at least two connection members fixed on the separated movable housings accordingly, and a sleeve engaging with the connection members outwards, which includes an upper opening and a lower opening, the nozzle protrude from the lower opening of the sleeve.

Preferably, the connection members have a conical outer surface, the sleeve has an upper opening, a lower opening and a conical inner surface, the conical outer surface of the connection members engages with the conical inner surface of the sleeve, and the nozzle protrude from the lower opening of the sleeve.

Preferably, the sleeve is stationary relative to the connection members, and the connection members with the housings operable to move up and down relative to the sleeve, the inner diameter of the nozzle will increase while the connection members move up, and decrease while the connection members move down.

Alternatively, the connection members with the housings are stationary relative to the sleeve, and the sleeve operable to move up and down relative to connection members, the inner diameter of the nozzle will increase while the sleeve moves down, and decrease while the sleeve moves up.

As another preferred embodiment, the actuating device comprises a horizontal actuator which includes at least two controlling members fixed on the separated movable housings accordingly, the inner diameter of the nozzle will increase while the horizontally controlling members move far away from each other, and decrease while the controlling members horizontally move toward each other.

As yet a preferred embodiment, further comprises a vacuum producing device operable to make the passage into vacuum state, so as to sucking in the solder ball positioned out of the nozzle.

Preferably, the inner diameter of the nozzle has a minimal size that is smaller than a diameter of the solder ball, while the housings of the nozzle device move together.

Preferably, the pressurized gas is an inert gas.

Preferably, the laser melts the solder ball before the solder ball drops down from the nozzle, with the housings are apart.

In comparison with the prior art, the present invention provides a nozzle device comprising two separated movable housings which can move together or apart by an actuating device, thus the inner diameter size of the nozzle is controllable to let the solder ball enter the passage via the upper entrance or the nozzle. Thus, the solder connection is easy to perform basing on this device. Additionally, as the inner diameter of the nozzle is controllable to allow the solder ball to enter from the nozzle, thus the laser beam can emit along with the dropping process of the solder ball; namely, the laser beam is emitted before the solder ball jetting out of the nozzle. Therefore, the inner wall of the nozzle will not be polluted and damaged without contacting the reflowing solder ball.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive unit;

FIG. 1b is a perspective view of a conventional HGA;

FIG. 1c is a partial detailed plan view of the suspension tongue shown in FIG. 1b;

FIG. 2 is a cross section view of the major portion of the HGA, and a partial cross sectional view of a conventional soldering device;

FIG. 3 is a partial view of the conventional nozzle device shown in FIG. 2;

FIG. 4 is a diagrammatic view of a soldering device according to one embodiment of the present invention;

FIG. 5a is a partial view of the nozzle device shown in FIG. 4;

FIG. 5b shows the separation status of the nozzle device of FIG. 5a;

FIG. 5c shows the closer status of the nozzle device of FIG. 5a;

FIG. 6a shows an actuating device according to a first embodiment of the present invention;

FIG. 6b shows a matching status of the actuating device and the nozzle device, which the nozzle becomes narrow;

FIG. 6c shows another matching status of the actuating device and the nozzle device, which the nozzle becomes wider;

FIG. 7 shows a cross section of the soldering device, which provides a solder ball via the entrance of the nozzle device;

FIG. 8 shows a cross section of the soldering device, which the solder ball is blocked between the nozzle;

FIG. 9 shows a cross section of the soldering device, which the solder ball is melted in the passage and jet from the nozzle;

FIG. 10 shows a cross section of the soldering device, which provides a solder ball via the nozzle;

FIG. 11 shows a cross section of the soldering device, which shows how the solder ball to be suck in the passage;

FIG. 12 shows a cross section of the soldering device, which the solder ball is melted during the falling of the solder ball from the nozzle; and

FIGS. 13a-13c show another actuating device according to a second embodiment of the present invention.

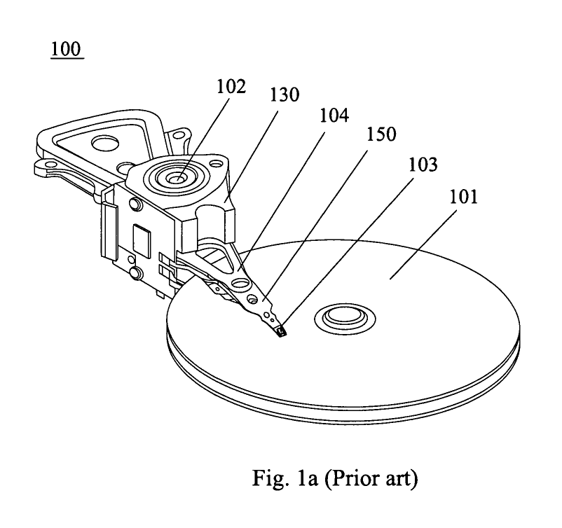

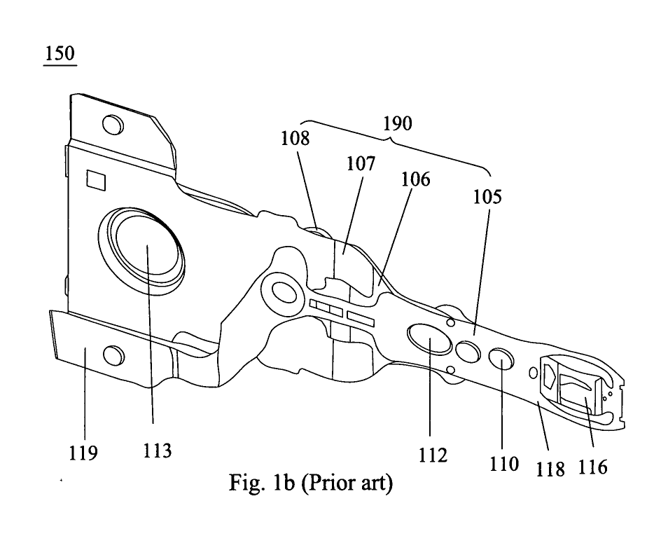

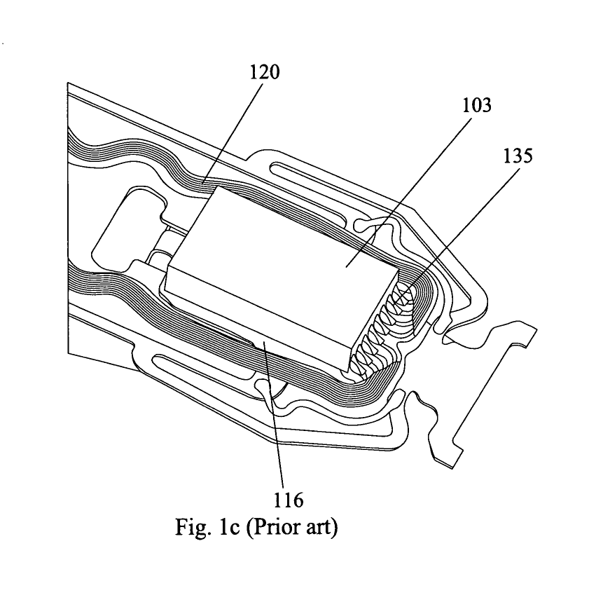

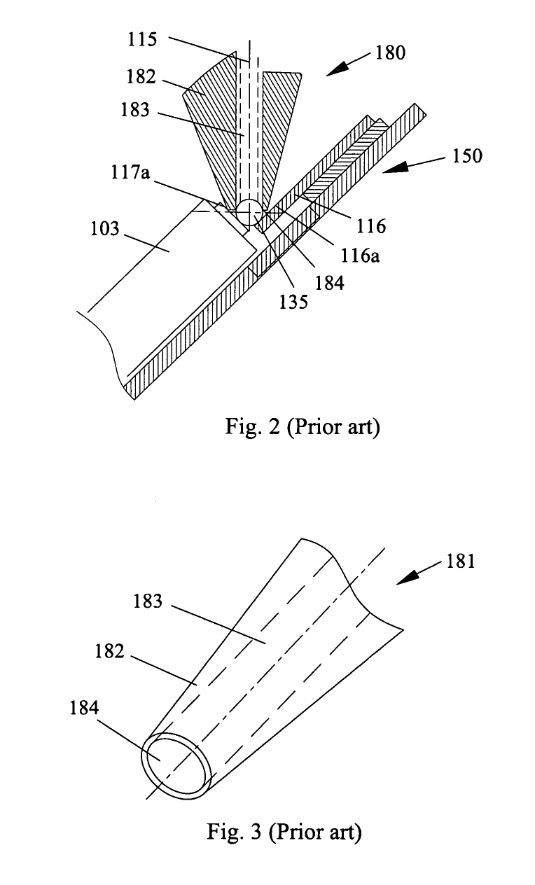

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a soldering device for forming electrical solder connections in a disk drive unit, which provides movable housings of the nozzle device, and in turn, makes the size of the nozzle controllable, finally benefits to perform a solder connection.

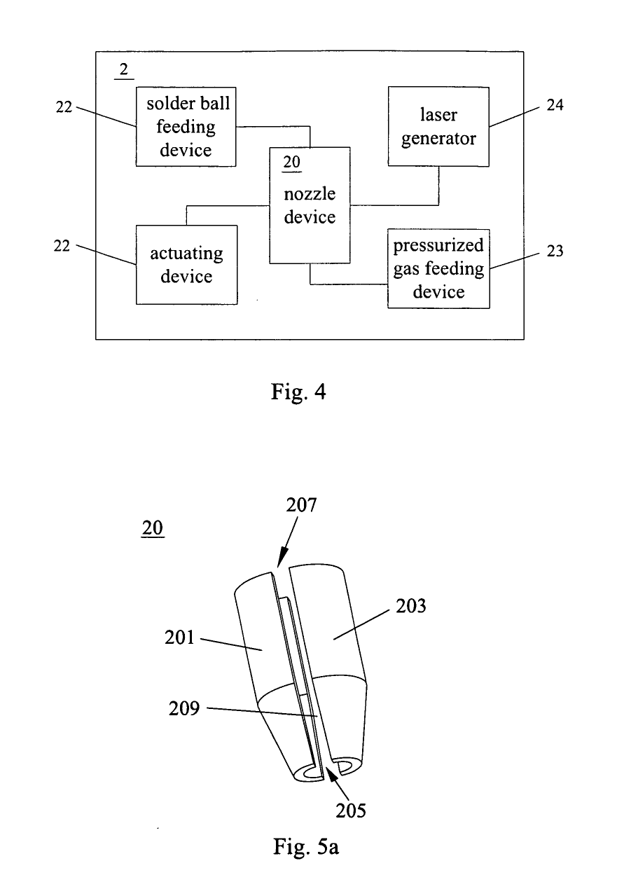

Referring to FIG. 4, the soldering device 2 according to one embodiment of the present invention comprises a nozzle device 20, an actuating device 21 for actuating the nozzle device 20, a solder ball feeding device 22, a pressurized gas feeding device 23 and a laser generator 24 equipped for the nozzle device 20. Concretely, the nozzle device 20 has separated movable housings for making the size of the nozzle variable, and the actuating device 21 controls to move the housings of the nozzle device 20. The solder ball feeding device 22 is arranged for supplying a signal solder ball to the nozzle device 20. The pressurized gas feeding device 23 is arranged for supplying pressurized gas to the interior of the nozzle device 20, thereby controlling the dropping speed of the solder ball inside the nozzle device 20. The laser generator 24 is arranged form emitting a laser beam to the interior of the nozzle device 20, for melting and reflowing the solder ball.

Now a detailed description of the soldering device 2 follows.

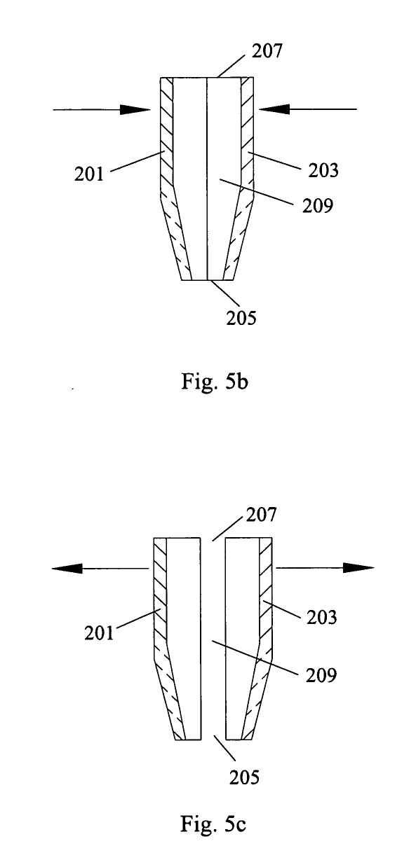

As shown in FIGS. 5a-5c, a partial view of the nozzle device 20 according to one embodiment of the present invention is presented. The nozzle device 20 includes two separated movable housings 201, 203, a nozzle 205 formed at the lower ends of the housings 201, 203, an entrance 207 formed at the upper ends of the housings 201, 203, and a passage 209 runs through the entrance 207 and the nozzle 205. As shown, the nozzle device 20 presents a cone, and the inner diameter of the entrance 207 is larger than that of the nozzle 205. The housings 201, 203 are separated each other, which can move together of apart actuated by the actuating device 21. As illustrated in FIG. 5b that shows the cross section view of the housings 201, 203 under a separation state. FIG. 5c shows the cross section view of the housings 201, 203 under a closer status. The sizes of the nozzle 205, entrance 207 and the passage 207 are variable and controllable.

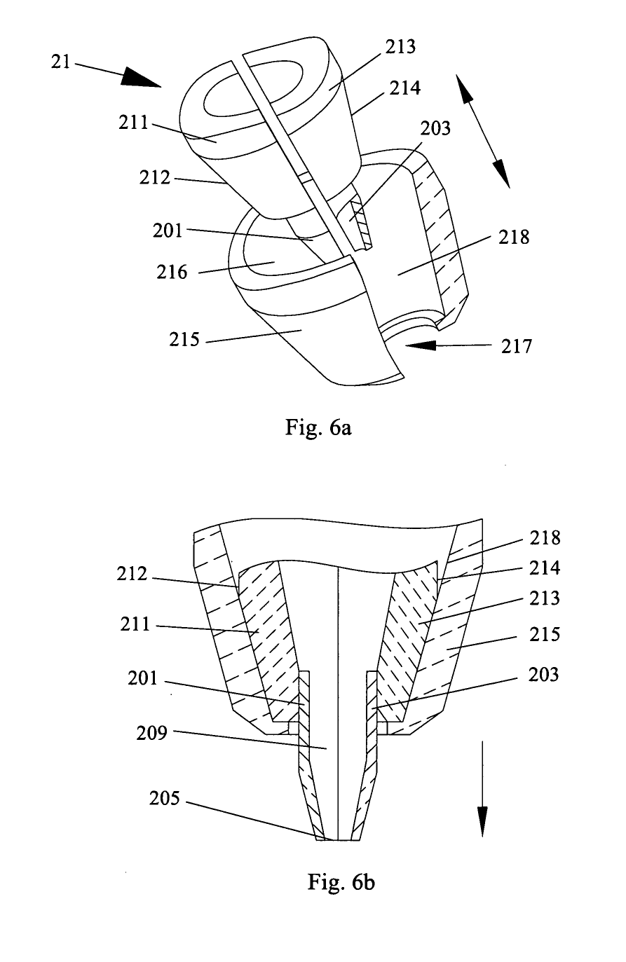

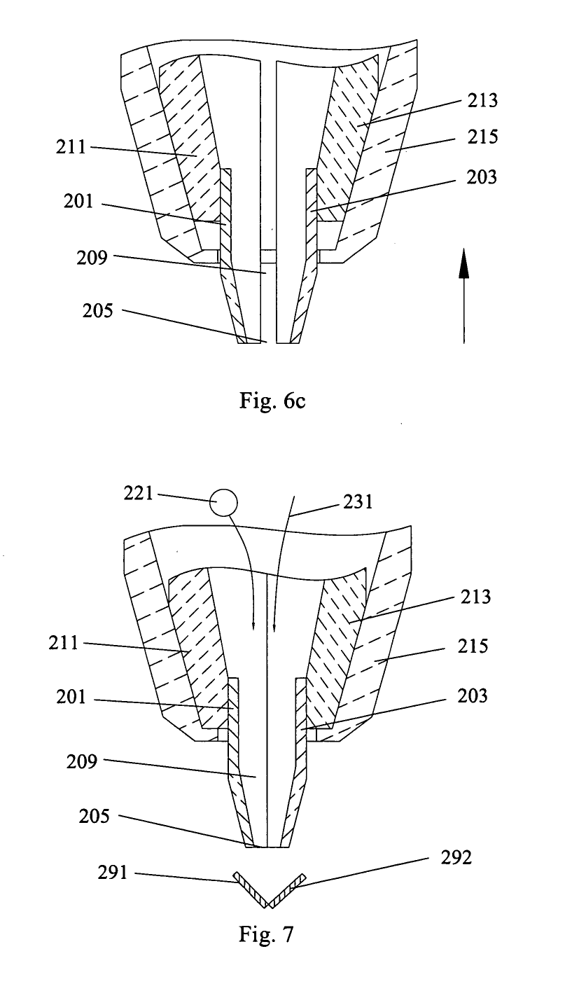

FIG. 6a illustrates the actuating device 21 according to a first embodiment of the present invention, which cooperates with the nozzle device 20. The actuating device 21 is a vertical actuator, which includes two connection members 211, 213 and a sleeve 215. In particular, the two connection members 211, 213 are fixed on the upper portion of the housings 201, 203 respectively, which have a corresponding shape with the housings 201, 203. The connection members 211, 213 have conical outer surfaces 212, 214 respectively. As shown, the sleeve 215 has an upper opening 216, a lower opening 217 and a conical inner surface 218. Concretely, the shape of the sleeve 215 is corresponding with the two connecting members 211, 213. For engaging with the connection members 211, 213, the size of the sleeve 215 is configured fitly to be large. Particularly, after engaging with the connection member 211, 213 with the nozzle device 20, the conical outer surfaces 212, 214 of the connection members 211, 213 cooperate with the conical inner surface 218 of the sleeve 215, which makes the nozzle device 20 move up and down along the conical inner surface 218 of the sleeve 215, as illustrated in FIGS. 6b-6c. And the nozzle 205 of the nozzle device 20 protrudes from the lower opening 217 of the sleeve 215.

As mentioned above, FIGS. 6b-6c show different matching status of the nozzle device 20 and the actuating device 21 according to a first embodiment of the present invention. In this embodiment, the sleeve 215 is stationary relative to the nozzle device 20, the nozzle device 20 can move up and down within the sleeve 215. When the connection members 211, 213 with the housings 201, 203 of the nozzle device 20 move down, the active housings 201, 203 gradually move together under the pressure of the narrowing inner wall (namely the conical inner surface 218) of the sleeve 215, which causes the inner diameter of the nozzle 205 decrease to the minimal size. Herein, the minimal size is slightly smaller than the diameter of a solder ball 221 (shown in FIG. 7) provide by the solder ball feeding device 22, thereby clamping the solder ball 221 delivered via the entrance 207 of the nozzle device 20.

When the connection members 211, 213 with the housings 201, 203 of the nozzle device 20 move up, the closer housings 201, 203 gradually move apart under the guiding of the acclivitous conical inner surface 218. In this moment, the inner diameter of the nozzle 205 increases, which benefits the solder ball 221 to enter the passage 208 via the wider nozzle 205.

Within a same contemplation, it also can design that the connection members 211, 213 with the housings 201, 203 are inactive and stationary in an up and down movement, and the sleeve 215 can move up and down relative to the connection members 211, 213. When the sleeve 215 moves down, the inner diameter of the nozzle 205 is broadened, when the sleeve 215 moves up, the inner diameter of the nozzle 205 is narrowed. As the size of the nozzle 205 is controllable, thus the solder ball 221 can be delivered via the upper end (namely the entrance 207) of the nozzle device 20 or the lower end (namely the nozzle 205) of the nozzle device 20.

Now a first soldering method using the soldering device 2 according to the present embodiment is described as following.

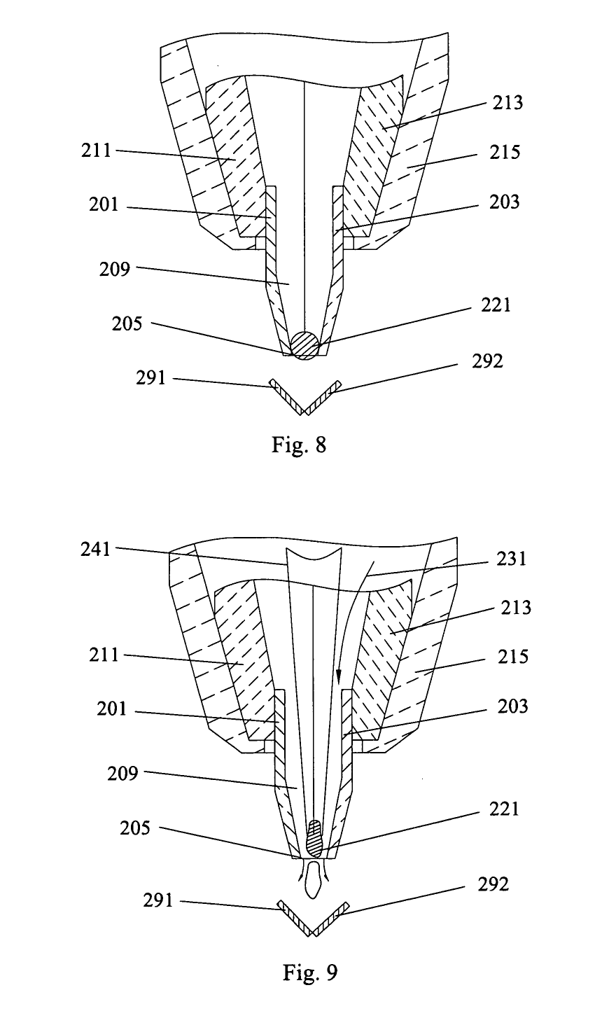

Referring to FIGS. 7-9, the housings 201, 203 of the nozzle device 20 are actuated to move together with the nozzle device 20 is engaging with the sleeve 215. Now, the nozzle 205 has a minimal size for clamping the solder ball 221. The solder ball 221 is provided by the solder ball feeding device 22 via the entrance 207 of the nozzle device 20. Meanwhile, the pressurized gas feeding device 23 supplies an inert gas along the arrow 231, such as nitrogen gas via the entrance 207, into the passage 208 of the nozzle device 20. The solder ball 221 falls down and then is blocked and clamping in the nozzle 205 under the pressure of the inert gas.

As shown in FIGS. 7-9, position the nozzle 205 above connection position of two pre-welding members 291, 292, and then focus a laser beam 241 emitting from the laser generator 24 on the solder ball 221, so as to melt the solder ball 221. The melted solder ball 221 jets out from the nozzle 205 under the pressure of the inert gas supplying along the arrow 231, and reflows to the pre-welding members 291, 292 to achieve solder connection.

Preferably, the housings 201, 203 are maintained separation, and the solder ball 221 enters at the entrance 207. Meantime, the laser beam 241 is emitted during the dropping of the solder ball 221 in the passage 208. That is, the solder ball 221 is melted before jetting out of the nozzle 205. Particularly, as the solder ball 221 locates at the wider passage 208, and jets out of the nozzle 205 without contacting the inner wall thereof, thus the inner wall of the nozzle 205 will not be polluted and damaged.

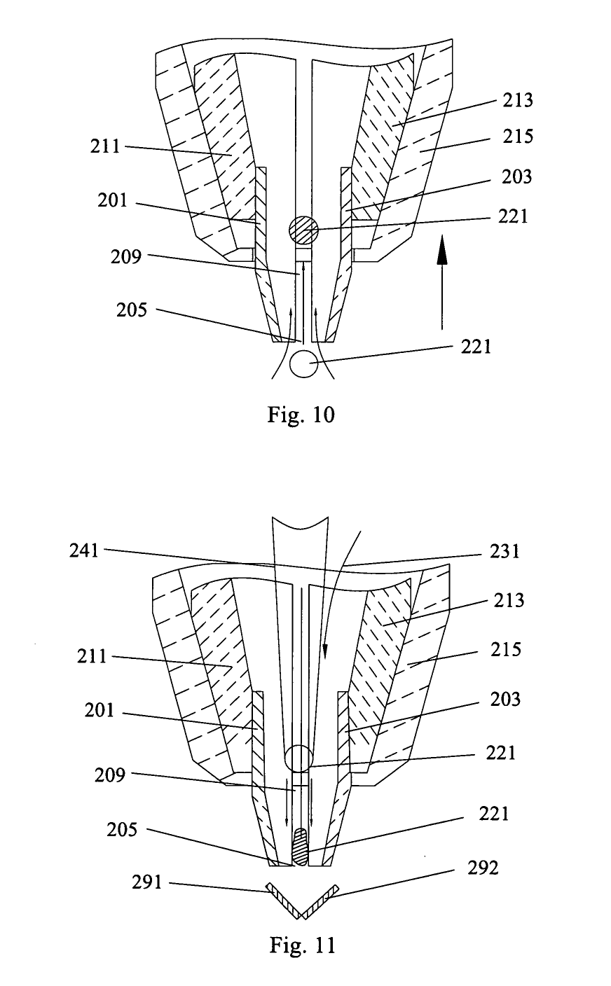

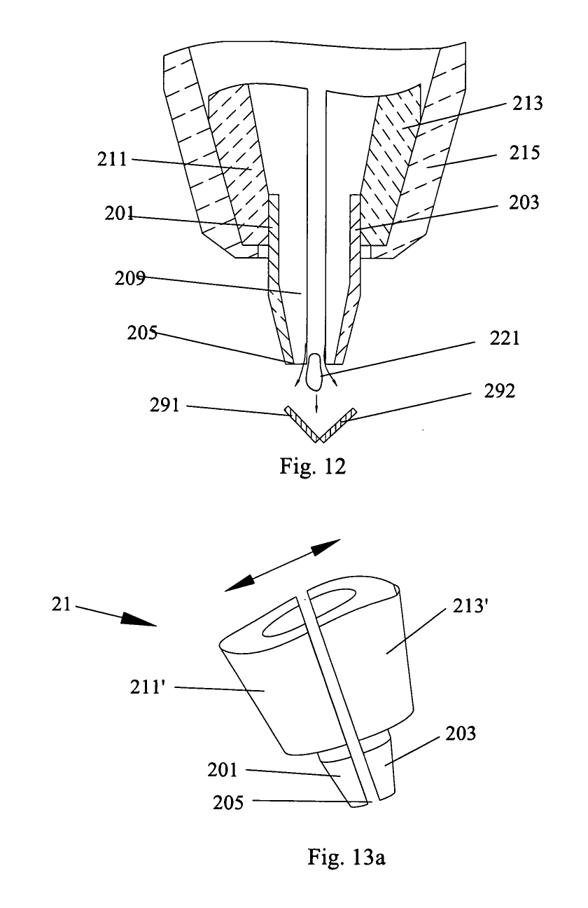

FIGS. 10-12 show a second method using the soldering device 2 according to an exemplary embodiment. One distinct difference between the first and the second methods is that, the solder ball 221 is provided to the passage 208 via the nozzle 205. And the solder device 2 further includes a vacuum producing device 25 in this embodiment.

The housings 201, 203 of the nozzle device 20 are actuated to move apart, with the nozzle 205 broadened. Thus the inner diameter of the nozzle 205 is larger than that of the solder ball 221, thereby causing the solder ball 221 to enter the passage 208 via the nozzle 205. Now, extract the air in the passage 208 of the nozzle device 20, so as to make the passage 208 into vacuum state. Under this case, the solder ball 221 out of the nozzle 205 is then sucked into the passage 208 at a predetermine height. Meanwhile, the pressurized gas feeding device 23 supplies an inert gas into the passage 208 of the nozzle device 20, so as to make the solder ball 221 drop down. During the dropping of the solder ball 221, emit the laser beam 241 to the solder ball 221, which makes the solder ball 221 melt along with the dropping process. The housings 201, 203 are apart each other during the melting and reflowing processes of the solder ball 221, that is, the inner diameter of the nozzle 205 is sufficiently larger than the solder ball 221 to allow it through without contacting the inner wall of the nozzle device 20. Thus, the melted solder ball 221 jets out from the nozzle 205 under the pressure of the inert gas, and reflows to the pre-welding members 291, 292 to achieve electrical solder connection.

As the inner diameter of the nozzle 205 is controllable, thus the solder ball 221 enters from the nozzle 205 by controlling the nozzle 205 wider, thus the laser beam 241 can emit along with the dropping process of the solder ball 221; namely, the laser beam 214 is emitted before the solder ball 221 jetting out of the nozzle 205. Therefore, the inner wall of the nozzle 205 will not be polluted and damaged without contacting the reflowing solder ball 221. Furthermore, the inert gas can be adjusted fitly to control the dropping speed of the solder ball 221, thereby melting the solder ball 221 more uniformly with the laser beam 241.

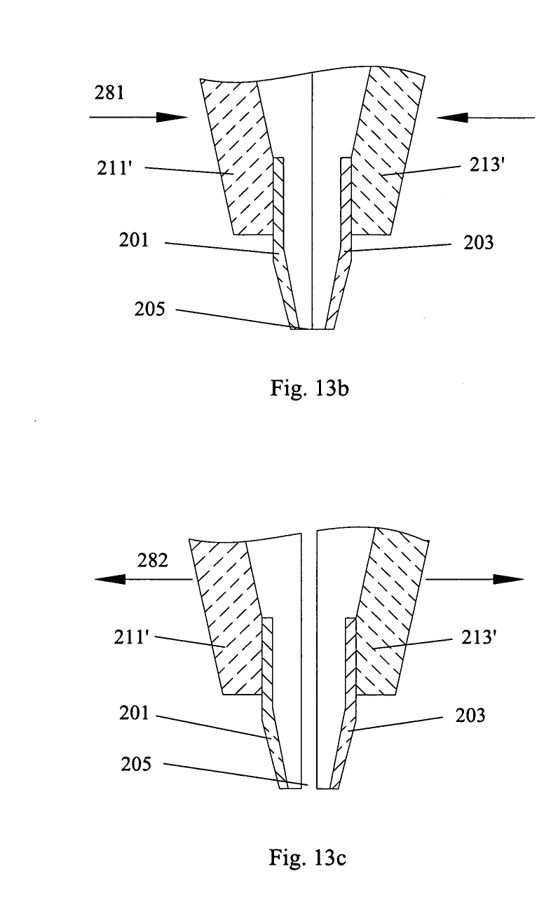

FIGS. 13a-13c illustrate the actuating device 21 according to a second embodiment of the present invention, which cooperates with the nozzle device 20. The actuating device 21 is a horizontal actuator, which includes two controlling members 211′, 213′. In particular, the two controlling members 211′, 213′ are fixed on the upper portion of the housings 201, 203 of the nozzle device 20 respectively, which have a corresponding shape with the housings 201, 203 in this embodiment. The controlling members 211′, 213′ can move horizontally to change the inner diameter size of the nozzle 205. When the controlling members 211′, 213′ move toward each other along the arrow 281, the inner diameter of the nozzle 205 will decrease, and when the controlling members 211′, 213′ move far away from each other along the arrow 282, the inner diameter of the nozzle 205 will increase.

The same soldering methods can be used as above, which also can obtain the same advantages, thus the verbose description is omitted hereon.

The soldering device 20 of the present invention can apply to any connection needed to connect in the disk drive unit, for example, an electrical solder connection between a slider and a suspension of a HGA, an electrical solder connection between a grounding pin or a voice lead provided on a fantail spacer and a FPC (flex printed circuit), an electrical solder connection between a suspension flexure of a HGA and a FPC, or an electrical solder connection between a PCBA (printed circuit board assembly) and a FPC, and the like.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A soldering device for forming electrical solder connections in a disk drive unit, comprising:
a nozzle device comprising at least two separated movable housings that provides a passage, the upper ends of the housings form an entrance, and the lower ends of the housings form a nozzle;
an actuating device connecting with the nozzle device and arranged for controlling the housings of the nozzle device to move together or apart, thereby controlling the inner diameter size of the nozzle;
a solder ball feeding device operable to deliver a single solder ball to the passage via the entrance or the nozzle;
a pressurized gas feeding device operable to supply pressurized gas to the passage, thereby controlling the dropping speed of the solder ball in the passage; and
a laser generator operable to emit a laser beam through the passage, thereby melting and reflowing the solder ball.

2. The soldering device according to claim 1, wherein the actuating device comprises a vertical actuator which includes at least two connection members fixed on the separated movable housings accordingly, and a sleeve engaging with the connection members outwards.

3. The soldering device according to claim 2, wherein the connection members have a conical outer surface, the sleeve has an upper opening, a lower opening and a conical inner surface, the conical outer surface of the connection members engages with the conical inner surface of the sleeve, and the nozzle protrude from the lower opening of the sleeve.

4. The soldering device according to claim 2, wherein the sleeve is stationary relative to the connection members, and the connection members with the housings operable to move up and down relative to the sleeve, the inner diameter of the nozzle will increase while the connection members move up, and decrease while the connection members move down.

5. The soldering device according to claim 2, wherein the connection members with the housings are stationary relative to the sleeve, and the sleeve operable to move up and down relative to connection members, the inner diameter of the nozzle will increase while the sleeve moves down, and decrease while the sleeve moves up.

6. The soldering device according to claim 1, wherein the actuating device comprises a horizontal actuator which includes at least two controlling members fixed on the separated movable housings accordingly, the inner diameter of the nozzle will increase while the horizontally controlling members move far away from each other, and decrease while the controlling members horizontally move toward each other.

7. The soldering device according to claim 1, wherein further comprises a vacuum producing device operable to make the passage into partial vacuum state, so as to sucking in the solder ball positioned out of the nozzle.

8. The soldering device according to claim 1, wherein the inner diameter of the nozzle has a minimal size that is smaller than a diameter of the solder ball, while the housings of the nozzle device move together.

9. The soldering device according to claim 1, wherein the pressurized gas is an inert gas.

10. The soldering device according to claim 1, wherein the laser melts the solder ball before the solder ball drops down from the nozzle, with the housings are apart.
